(19) United States
(12) Patent Application Publication
(10) Pub. No.: US 2018/0173357 A1
(43) Pub. Date: Jun. 21, 2018

(54) FORCE SENSOR DOT PATTERN

(71) Applicant: STMicroelectronics Asia Pacific Pte Ltd, Singapore (SG)

(72) Inventors: Dylan Park, Yongin-Si (KP); John Serge Georges Nankoo, Singapore (SG)

(73) Assignee: STMicroelectronics Asia Pacific Pte Ltd, Singapore (SG)

(21) Appl. No.: 15/384,494

(22) Filed: Dec. 20, 2016

(51) Int. Cl. G06F 3/041; G06F 3/044

(52) U.S. Cl. CPC G06F 3/0414; G06F 3/044; G06F 2203/04101; G06F 2203/04111; G06F 3/0416

(57) ABSTRACT

The present disclosure provides a capacitive sensing structure for detecting a force touch in a touchscreen application. Performance uniformity of the force touch sensor is improved by providing a capacitive force touch structure having dot-pattern sensing electrodes of varying thickness, wherein the variation in electrode thickness corresponds to a relative displacement potential of portions of the sensing electrode. This variation in thickness improves performance uniformity of the force sensor by compensating for the displacement potential (i.e., flexibility) of the sensing electrodes so that a force touch applied to the touch surface is measured consistently regardless of the location of the force touch on the touch surface.

### FIELD OF THE INVENTION

The present disclosure generally relates to capacitive touchscreen panels and, more particularly, to one or more force sensor patterns for use in capacitive touchscreens.

### BACKGROUND

Touchscreen displays have become ubiquitous in current mobile platform applications, such as smart phones. Touchscreen displays eliminate the need for keypads and, in some implementations, act as a user interface that detects user gestures on a touchscreen and translates gestures into user input.

Conventionally, touchscreen displays include an LCD (liquid crystal display) screen, or other similar display technology, coupled with touch-sensor technology such as, for example, capacitive, resistive, infrared, or surface acoustic wave technologies, to determine one or more points of user contact with the touchscreen. These touch-sensing technologies, however, detect user input in only two dimensions in the plane of display. For example, FIG. 1 illustrates a prior art mobile device 10 having a touchscreen 12 that detects two-dimensional touch information along an X-axis and a Y-axis. The embodiment illustrated in FIG. 1 is capable of detecting a user touch in two dimensions using a touch sensor arrangement such as that illustrated in FIG. 2 and described below.

FIG. 2 illustrates a prior art, diamond-shaped sensor pattern 100 for use in a capacitive touchscreen, such as the touchscreen 12 shown in FIG. 1. The sensor pattern 100 includes a first set of diamond-shaped sensors 102, often referred to in the art as the transmit sensors or transmit electrode structure. The sensors 102 are arranged in a matrix such that sensors 102 in each column are connected to each other by a connecting member 104. The sensors 102 in adjacent columns are isolated from each other. The sensor pattern 100 also includes a second set of diamond-shaped sensors 112, often referred to in the art as the receiving sensors or receive electrode structure. The sensors 112 are arranged in a matrix such that sensors 112 in each row are connected to each other by a connecting member 114. The sensors 112 in adjacent rows are isolated from each other.

The matrix of the diamond-shaped sensors 102 is interleaved with the matrix of diamond-shaped sensors 112 in a manner where the space between a group of four diamond-shaped sensors 102 is occupied by one of the diamond-shaped sensors 112, and the space between a group of four diamond-shaped sensors 112 is occupied by one of the diamond-shaped sensors 102.

In some embodiments, the first and second sets of sensors 102 and 112 and connecting members 104 and 114 are made of a single patterned material layer, wherein connecting members 104 provide bridged connections to sensors 102 over the connecting members 114, or connecting members 114 provide bridged connections to sensors 112 over the connecting members 104. In other embodiments, the sensors 102 and connecting members 104 are made of a first patterned material layer, and the sensors 112 and connecting members 114 are made of a second patterned material layer. In the embodiments discussed herein, the material layers may comprise relevant materials known in the art such as, for example, indium tin oxide (ITO), and may be supported by a transparent substrate layer.

In embodiments wherein the sensor pattern comprises multiple material layers, the first and second patterned material layers are isolated from each other by an interposed insulating layer. The first patterned material layer including diamond-shaped sensors 102 and connecting members 104 may comprise the lower layer of the capacitive touchscreen, and the second patterned material layer including diamond-shaped sensors 112 and connecting members 114 may comprise the upper layer (as shown in FIG. 2), or vice versa. The insulating layer, first patterned material layer, and second patterned material layer are supported by a transparent substrate layer.

The prior art diamond-shaped sensor pattern described above typically overlays a display screen in a stacked configuration. Commonly, that display screen is a liquid crystal display (LCD) although other display technologies may also be used. In operation, these prior art sensor patterns detect user input in two dimensions: along the X- and Y-axes.

To detect a user touch input in three dimensions, force touch sensors may be used. Conventional force touch sensors use the pressure or force generated from a user touch to provide a third dimension to the touch detection. However, conventional force touch sensors incur undesirable amounts of parasitic capacitance and suffer with respect to performance uniformity. Accordingly, a need exists in the art for improved force sensor patterns for use in capacitive touchscreen applications.

### SUMMARY

The present disclosure provides a capacitive sensing structure, comprising: a touch surface; one or more sensing electrodes disposed between the touch surface and a ground plane, the one or more sensing electrodes having a matrix of nodes, wherein each node is spaced apart from an adjacent node by a first distance; and control circuitry configured to sense a capacitance at the one or more sensing electrodes, wherein a change in the capacitance at the one or more sensing electrodes is indicative of a force touch.

In another embodiment, the present disclosure provides a capacitive sensing structure, comprising: one or more sensing electrodes formed from a matrix of nodes, the one or more sensing electrodes defined by the matrix of nodes and disposed between a ground plane and a touch surface, wherein each node is spaced apart from an adjacent node by a first distance, and wherein each of the one or more sensing electrodes is spaced apart from an adjacent sensing electrode by the first distance; and control circuitry configured to sense a capacitance at the one or more sensing electrodes, wherein a change in the capacitance at the one or more sensing electrodes is indicative of a force touch.

The foregoing and other features and advantages of the present disclosure will become further apparent from the following detailed description of the embodiments, read in conjunction with the accompanying drawings. The detailed description and drawings are merely illustrative of the disclosure, rather than limiting the scope of the invention as defined by the appended claims and equivalents thereof.

### BRIEF DESCRIPTION OF DRAWINGS

Embodiments are illustrated by way of example in the accompanying figures not necessarily drawn to scale, in which like numbers indicate similar parts, and in which:

FIG. 1 illustrates a prior art mobile device having a touchscreen that detects two-dimensional touch information along an X-axis and a Y-axis;

FIG. 2 illustrates a prior art diamond-shaped sensor pattern for use in a capacitive touchscreen to detect two-dimensional touch information along an X-axis and a Y-axis;

FIG. 3 illustrates a schematic diagram representing a cross-sectional view of an example embodiment of an electronic device for implementing the disclosed capacitive sensing structure;

FIG. 4 illustrates a schematic diagram of an example embodiment of control circuitry coupled to touch sensor circuitry and force sensor circuitry;

FIGS. 5A, 5B, and 5C illustrate an example force sensor having one or more sensing electrodes positioned above a ground plane;

FIGS. 6A, 6B, 6C, and 6D illustrate example embodiments of a force sensing structure having a plurality of triangularly shaped sensing electrodes extending radially from a center location of the force sensing structure;

FIGS. 7A and 7B illustrate an example embodiment of a force sensing structure having rows of triangularly shaped sensing electrodes;

FIGS. 8A and 8B illustrate an example embodiment of a force sensing structure having a matrix of rectangle-shaped sensing electrodes;

FIGS. 9A and 9B illustrate an example embodiment of a force sensing structure having a matrix of rectangular sensing electrodes having a spiral pattern;

FIGS. 10A and 10B illustrate example embodiment of a force sensing structure having a matrix of rectangular sensing electrodes, wherein the rectangular sensing electrodes have a rectangular pattern defining an aperture;

FIG. 11 illustrates an example embodiment of a force sensing structure having a plurality of rectangular rings; and

FIGS. 12A, 12B, and 12C illustrate example embodiment of a force sensing structure having a matrix of nodes.

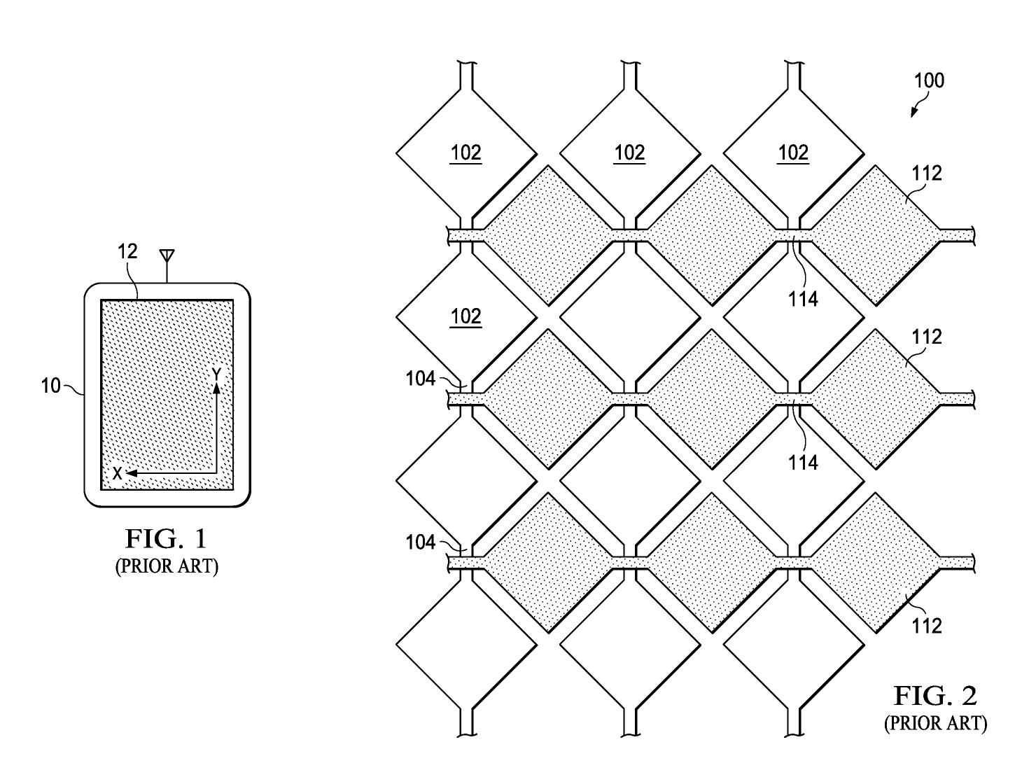

### DETAILED DESCRIPTION OF THE EMBODIMENTS

In the following detailed description and the attached drawings, numerous specific details are set forth to provide a thorough understanding of the present disclosure. Those skilled in the art will appreciate, however, that the present disclosure may be practiced, in some instances, without such specific details. In other instances, well-known elements have been illustrated in schematic or block diagram form in order not to obscure the present disclosure in unnecessary detail. Additionally, for the most part, specific details, and the like, have been omitted inasmuch as such details are not considered necessary to obtain a complete understanding of the present disclosure, and are considered to be within the understanding of persons of ordinary skill in the relevant art.

It is further noted that, unless indicated otherwise, all functions described herein may be performed in hardware or as software instructions for enabling a computer or other electronic device to perform predetermined operations, where the software instructions are embodied on a computer readable storage medium, such as RAM, a hard drive, flash memory or other type of computer readable storage medium known to a person of ordinary skill in the art. In certain embodiments, the predetermined operations of the computer, radio or other device are performed by a processor such as a computer or an electronic data processor in accordance with code such as computer program code, software, firmware, and, in some embodiments, integrated circuitry that is coded to perform such functions. Furthermore, it should be understood that various operations described herein as being performed by a user may be operations manually performed by the user, or may be automated processes performed either with or without instruction provided by the user.

The present disclosure provides a capacitive sensing structure for detecting a force touch in a touchscreen application. The capacitive sensing structure may be implemented in various electronic devices such as, for example, smartphones, tablet computers, or any other device that implements a touchscreen. When compared to conventional force touch sensors, the disclosed capacitive sensing structure reduces parasitic capacitance and improves performance uniformity of the force touch sensor.

Specifically, parasitic capacitance is reduced by using a capacitive sensing structure that has at least one of: (a) a sensing electrode having a reduced size or surface area, and (b) arranging the sensing structure such that there is an increasing distance between the sensing electrode and an underlying ground plane such that the parasitic capacitance formed between the sensing electrode and ground plane is reduced.

Performance uniformity of the force touch sensor is improved by providing a capacitive force touch structure having sensing electrodes of varying thickness, wherein the variation in electrode thickness corresponds to a relative displacement potential of portions of the sensing electrode. This variation in thickness improves performance uniformity of the force sensor by compensating for the displacement potential (i.e., flexibility) of the sensing electrodes so that a force touch applied to the touch surface is measured consistently regardless of the location of the force touch on the touch surface.

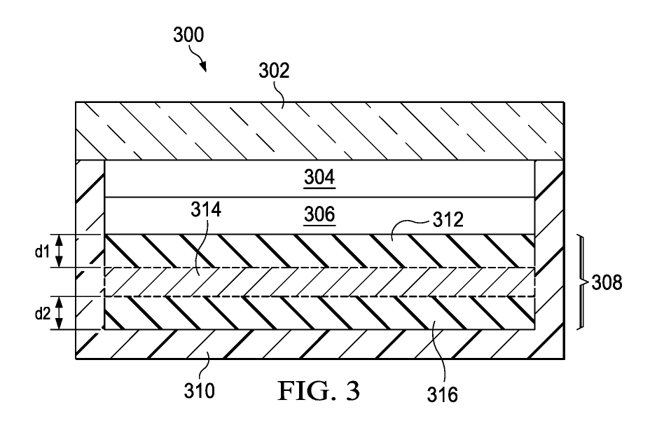

Referring now to FIG. 3, a cross-sectional view of an example embodiment of an electronic device 300 for implementing the disclosed capacitive sensing structure is shown having a touch surface 302 (e.g., cover glass), two-dimensional touch sensor circuitry 304 (e.g., similar to that illustrated in FIG. 2), display circuitry 306 (including, for example, low-temperature polysilicon glass), force sensor circuitry 308, and a frame member 310, which serves as an electrical ground. In some embodiments, the frame member 310 may include the frame or bracket of the electronic device and may be positioned over other components such as a battery and mainboard (not shown).

In the embodiment illustrated in FIG. 3, the force sensor circuitry 308 includes one or more sensing electrodes 314, a first cushion 312 separating the one or more sensing electrodes 314 from the display circuitry 306 by distance d1, and a second cushion 316 separating the one or more sensing electrodes 314 from the frame member 310 by a distance d2.

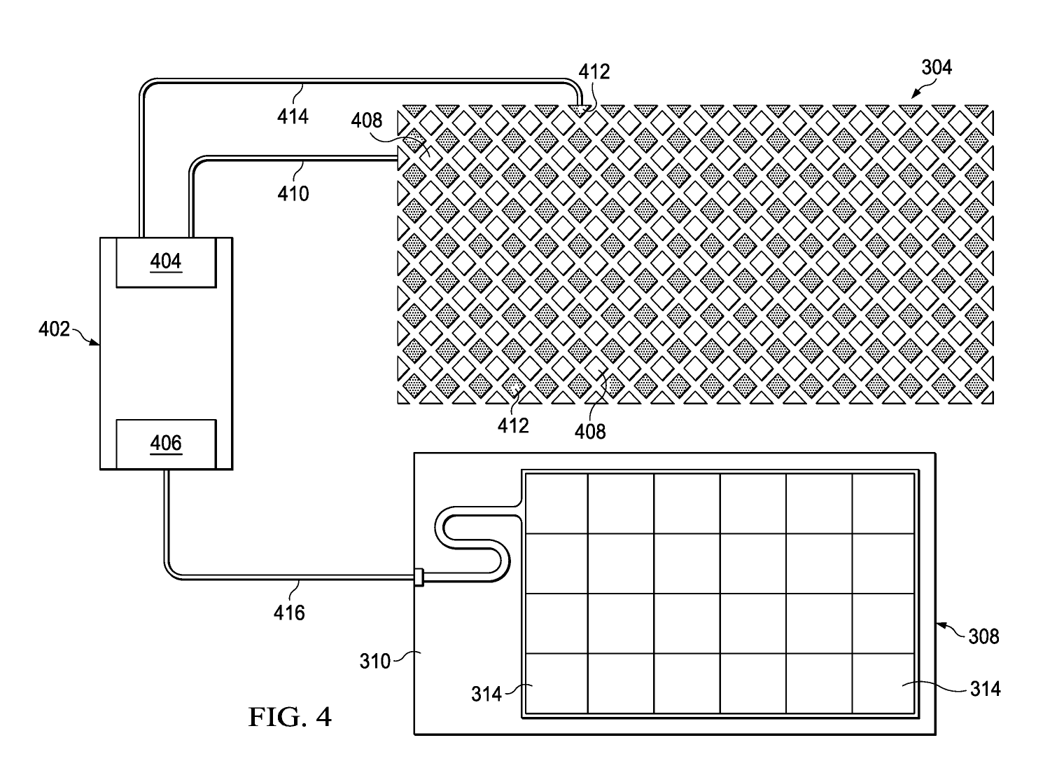

In some embodiments, the electronic device may include control circuitry for controlling the two-dimensional touch sensor circuitry 304 and the force sensor circuitry 308. For example, FIG. 4 illustrates a schematic diagram of an example embodiment wherein control circuitry 402 includes touch-sensing circuitry 404 and force-sensing circuitry 406 for controlling the two-dimensional touch sensor circuitry 304 and the force sensor circuitry 308, respectively. FIG. 4 shows an overhead view of the touch sensor circuitry 304, wherein the touch-sensing circuitry 404 is coupled to receiving sensors 408 of the touch sensor circuitry 304 by receive traces 410, and is coupled to transmit sensors 412 of the touch sensor circuitry 304 by transmit traces 414. The touch-sensing circuitry 404 controls operation of the touch sensor circuitry 304 to detect a user touch on the touch surface 302, wherein the user touch is determined in two dimensions: along an X-axis and a Y-axis positioned on a plane substantially parallel to the touch surface 302.

FIG. 4 shows an overhead view of the force sensor circuitry 308, wherein the force-sensing circuitry 406 is coupled to a plurality of sensing electrodes 314 by force traces 416. The force sensor circuitry 308 includes the frame member 310, sensing electrodes 314 arranged in a grid formation, and the first and second cushions 312 and 316 (not shown in FIG. 4). As explained in greater detail below, the force-sensing circuitry 406 senses a change in capacitance at the sensing electrodes 314 as a force is applied to the touch surface and, consequently, to the sensing electrodes 314. This change in capacitance is indicative of the force applied to the touch surface, and may be assigned a value to indicate a user touch input in a third dimension (i.e., a force touch). For example, the third dimension may be a direction extending along a Z-axis substantially perpendicular to the touch surface 302, two-dimensional touch sensor circuitry 304, force sensors 314, or the frame member 310.

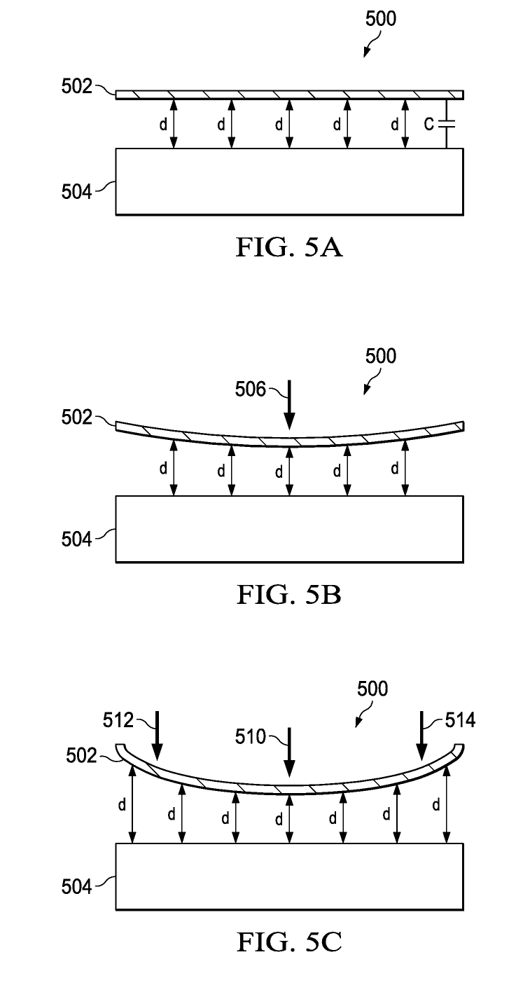

Reference is now made to FIGS. 5A, 5B, and 5C, which illustrate a cross-sectional view of an example force sensor structure 500 having one or more sensing electrodes 502 positioned above a ground plane 504, such as, for example, the frame member of the electronic device. The sensing electrodes 502 are spaced apart from the ground plane 504 by a distance d. In operation, the sensing electrodes 502 are flexible conductors that receive a voltage. As shown in FIG. 5B, as the user applies a force to the touch surface, a force 506 is applied to the sensing electrodes 502, causing the sensing electrodes 502 to flex in a direction toward the ground plane 504, thereby decreasing the distance d between the sensing electrodes 502 and the ground plane 504. As the sensing electrodes 502 approach the ground plane 504, the ground plane 504 interferes with a fringe electric field of the sensing electrodes 502, thereby forming (or altering) a capacitance C between the sensing electrodes 502 and the ground plane 504. The capacitance C is inversely proportional to the distance d between a sensing electrode 502 and the ground plane 504. Thus, the closer a sensing electrode 502 is to the ground plane 504, the greater the capacitance C. This capacitance, which is used to measure a force touch, may be represented by the following equation:

C=ε₀εᵣA/d
wherein C=capacitance,
ε₀=permittivity of free space,
εᵣ=relative permittivity of the material between the sensing electrode 502 and the ground plane 504,
A=area of the sensing electrode 502, and
d=the distance between the sensing electrode 502 and the ground plane 504.

The displacement potential of respective sensing electrodes 502 is dependent upon the location of the sensing electrode 502 with respect to the structure of the electronic device. In other words, the displacement of the sensing electrode 502 (that is, the change in d for a given force) may depend, at least in part, on where the sensing electrode 502 is positioned proximate the touch surface. For example, as illustrated in FIG. 5C, a force 510 applied to sensing electrodes 502 proximate a center location of the touch surface (not shown) may result in greater displacement of those sensing electrodes 502 when compared to the displacement of sensing electrodes 502 proximate perimeter locations of the touch surface (not shown) having equal forces 512 and 514 applied thereto. In this example, the frame or structure of the electronic device inhibits movement of the touch surface and, consequently, the underlying sensing electrodes 502, at locations near the frame of the electronic device (usually a perimeter of the touch surface). Thus, movement of points farther way from the frame or structure of the electronic device is generally less restricted than points proximate the perimeter of the touch screen. As such, sensing electrodes 502 positioned proximate these points (e.g., a center region of the touch surface) will typically exhibit greater displacement for a force applied at these points, than will sensing electrodes 502 positioned proximate the frame or structure, which is generally located along a perimeter, or peripheral edge, of the touch surface. This potential for movement of the sensing electrodes 502 is referred to herein as displacement potential.

As a result of the foregoing, a force touch applied to the touch surface causes the capacitance at the respective sensing electrodes 502 proximate the location of the force touch to adjust depending upon the displacement potential of those sensing electrodes 502. In other words, the measurement of a force touch is dependent upon the displacement potential of the sensing electrodes 502 proximate the location of the force touch. Thus, a force touch applied to a location near the perimeter of the touch surface is measured differently than a force touch of equal force applied to a location near the center of the touch surface. In such embodiments, uniformity of performance is not maintained because the force touch measurement is subject to the displacement potential of the sensing electrodes 502 without any compensation in this regard.

The present disclosure provides a capacitive force touch structure that provides uniform force touch measurement by compensating for the displacement potential of the sensing electrodes. Specifically, the force sensor incorporates sensing electrodes having varying thicknesses, wherein the variation in thickness corresponds to a relative displacement potential of portions of the sensing electrode. This variation in thickness improves performance uniformity of the force sensor by compensating for the displacement potential of the sensing electrodes so that a force touch applied to the touch surface is measured consistently regardless of the location of the force touch on the touch surface.

The following embodiments of force sensing structures may be implemented in an electronic device environment similar to that discussed above with respect to FIGS. 3 and 4, and operate similar to the force sensing structures discussed above with respect to FIGS. 5A, 5B, and 5C, except that the sensing electrodes are designed to have varying thickness and are arranged in different force sensor patterns. In the embodiments disclosed herein, the shape or pattern of one or more sensing electrodes is used to describe a length, width, and/or arrangement of one or more sensing electrodes with respect to an overhead view (i.e., plan view) of the sensing electrodes along the X-Y axes, whereas the thickness of a sensing electrode is used to describe a depth of a sensing electrode structure with respect to the Z axis.

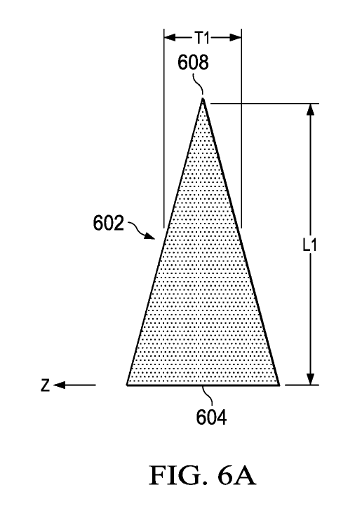

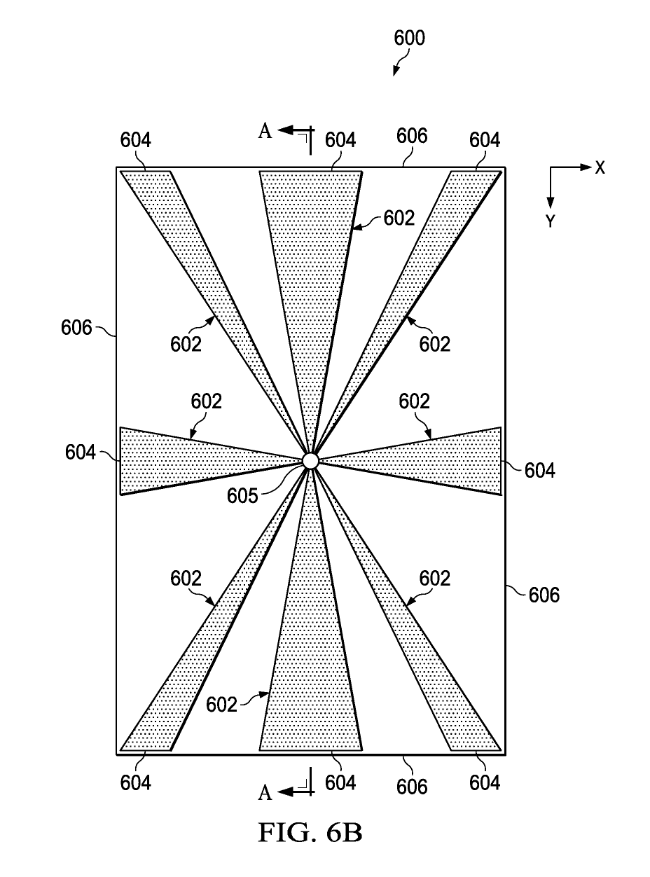

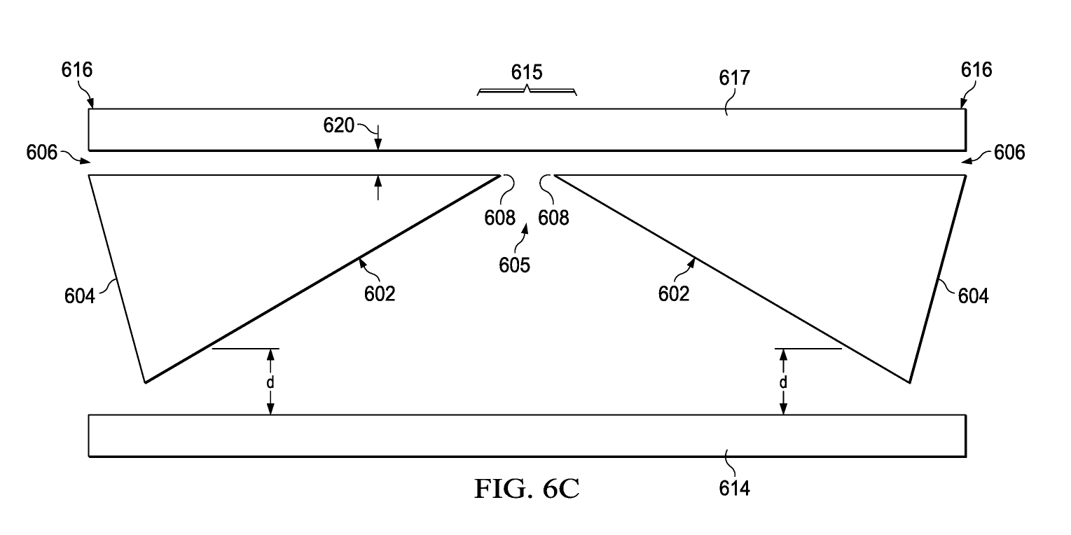

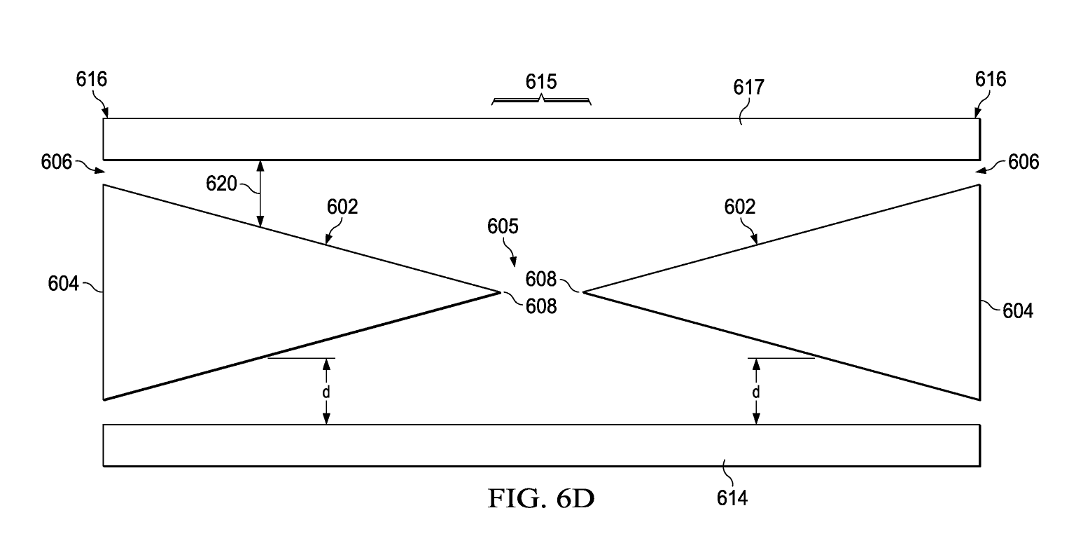

For example, FIGS. 6A, 6B, and 6C illustrate an example embodiment of a force sensing structure 600 having a plurality of triangularly shaped (as viewed from the overhead view in FIG. 6B) sensing electrodes 602 extending radially from a center location 605 of the force sensing structure 600. FIG. 6A shows a cross-sectional view of the triangularly shaped sensing electrode 602, wherein the electrode 602 has a base portion 604 and a tip portion 608. The sensing electrode 602 has a thickness T1, which varies along the length L1 of the sensing electrode 602 such that the thickness T1 is largest at the base portion 604 and is smallest at the tip portion 608. In some embodiments, the thickness T1 is selected to vary so that it follows the exponential function: y=exp(x), wherein y is the thickness T1 and x is a point along the length L1 of the sensing electrode 602, such that the thickness T1 increases exponentially as it approaches the base portion 604. In some embodiments, the sensing electrode 602 may have a thickness of 100 μm at the tip portion 608, and a thickness of 1000 μm at the base portion 604.

As previously discussed, the variation in thickness T1 corresponds, inversely, to a relative displacement potential of portions of the sensing electrode 602. Because the displacement potential of the sensing electrode 602 is greatest at the tip portion 608, and is smallest at the base portion 604, a force touch applied to the touch surface at a location near the tip portion 608 will effectuate a larger change in distance d than will an equal force touch applied to the touch surface near the base portion 604. Accordingly, the sensing electrode 602 is designed to have a thickness T1 that is greatest at the base portion 604 and is smallest at the tip portion 608. This variation in thickness T1 improves performance uniformity of the force sensor 600 by compensating for the variation in displacement potential of the sensing electrodes 602 so that a force touch applied to the touch surface is measured consistently regardless of the location of the force touch on the touch surface.

The consistency in the force touch measurement is achieved by measuring the change in the capacitance at the sensing electrode 602, which is caused by the change in distance d (and the corresponding displacement toward the ground plane) resulting from the force touch applied to the touch surface. By providing a variation in thickness in accordance with the present disclosure (e.g., larger thickness T1 at the base portion 604 and a smaller thickness T1 at the tip portion 608, or in accordance with the above exponential function), a smaller change in the distance d will register a change in capacitance at the sensing electrode 602 that is comparable to the change in capacitance that is caused by the resulting displacement of the tip portion 608 when an equal force touch is applied near the center location 615 of the touch surface. The thickness T1 is selected to vary along the length L1 such that this relationship is maintained along the length L1 of the sensing electrode 602, so that a similar change in capacitance is measured at the sensing electrode 602 for a consistent force touch applied to the touch surface, regardless of the location of the force touch on the touch surface.

FIG. 6B shows an overhead view of the force sensing structure 600, wherein the triangularly shaped sensing electrodes 602 are arranged to extend radially from a center location 605 of the force sensing structure 600 such that the base portions 604 are positioned proximate perimeter locations 606 of the sensing structure 600, and the tip portions 608 are positioned proximate the center location 605 of the sensing structure 600. As discussed herein, the displacement potential of the sensing electrodes 602 is greatest in locations near the center location 605, and is least in locations near the perimeter locations 606. In some embodiments, the center location 605 may be a circular region having a radius of 2.5 mm.

FIGS. 6C and 6D show different embodiments of a cross-sectional view of the force sensing structure 600 as viewed along line A-A of FIG. 6B. The embodiments illustrated in FIGS. 6C and 6D show the touch surface 617 positioned over the sensing electrodes 602, and the ground plane 614 positioned below the sensing electrodes 602 and spaced apart from the sensing electrodes 602 by a distance d. The center location 605 of the force sensing structure 600 is positioned proximate a center location 615 of the overlying touch surface 617, and the perimeter locations 606 of the force sensing structure 600 are positioned proximate perimeter locations 616 of the overlying touch surface 617. The sensing electrodes 602 are spaced apart from the ground plane 614 by the distance d, which is defined, at least in part, by the thickness T1 of the sensing electrodes 602.

In the embodiment shown in FIG. 6C, the tip portions 608 of the sensing electrodes 602 are angled toward the overlying touch surface 617 such that a spacing 620 between the sensing electrodes 602 and surface 617 is substantially consistent across the force sensing structure 600. In the embodiment shown in FIG. 6D, the sensing electrodes 602 are aligned such that the base portions 604 are substantially parallel to an imaginary plane (not shown) extending perpendicular to the ground plane 614, such that a spacing 620 between the sensing electrodes 602 and overlying touch surface 617 varies along the lengths of the sensing electrodes 602. Although it is not shown in FIG. 6C or FIG. 6D, in some embodiments, the force sensing structure 600 may include a first cushion between the touch surface 617 and the sensing electrodes 602, and a second cushion between the sensing electrodes 602 and the ground plane 614.

As previously discussed, as a force touch is applied to the touch surface 617, the force of the touch causes a displacement of the sensing electrode(s) 602 positioned beneath the force touch, such that the sensing electrode(s) 602 flex in a direction toward the ground plane 614, thereby causing a relative change in distance d, and altering the capacitance measured at the sensing electrodes 602. This change in the capacitance is measured by control circuitry (such as, for example, the control circuitry 402 or 406 in FIG. 4) to determine the force of the force touch or to otherwise assign a value to the measured force touch. This value correlates to some user touch input (i.e., force touch input) applied in a direction substantially perpendicular to the touch surface 617, the sensing electrodes 602, or the ground plane 614. In some embodiments, this user touch input (i.e., the force touch input) is used by the control circuitry or other circuitry in the electronic device to perform a task, or is otherwise associated with a user input.

The following embodiments of the present disclosure are designed to operate in accordance with the foregoing disclosure unless specified otherwise. Therefore, operation of the following force sensor embodiments and the design of the sensing electrode thickness are not discussed in detail as these details should be apparent from the foregoing disclosure.

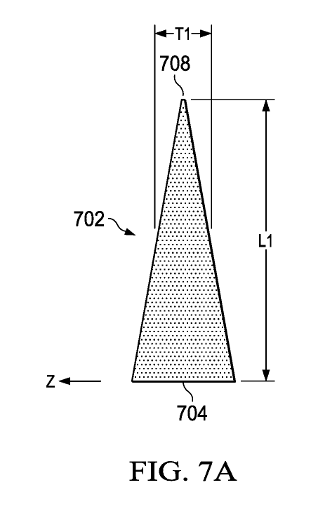

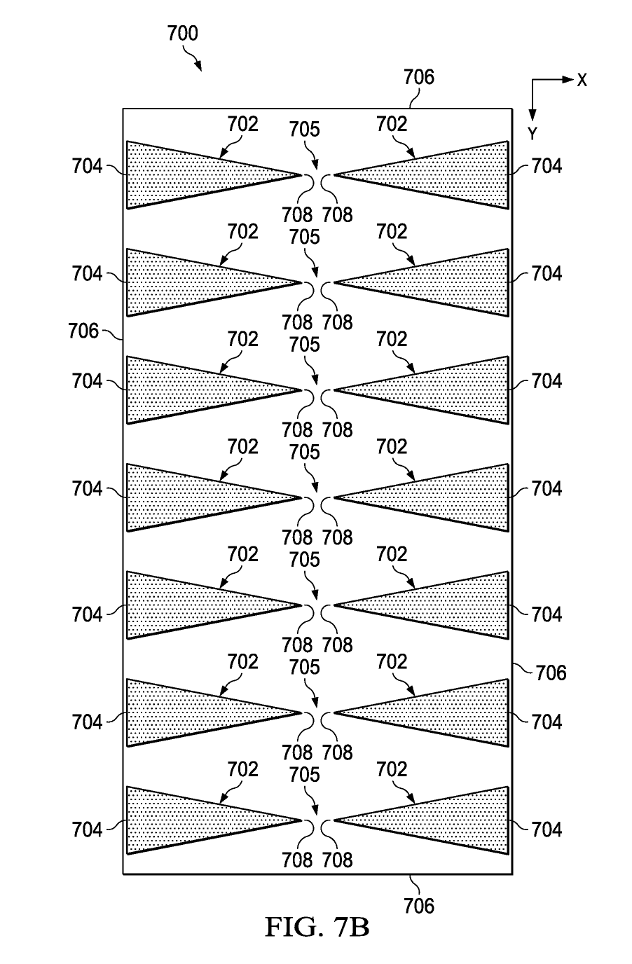

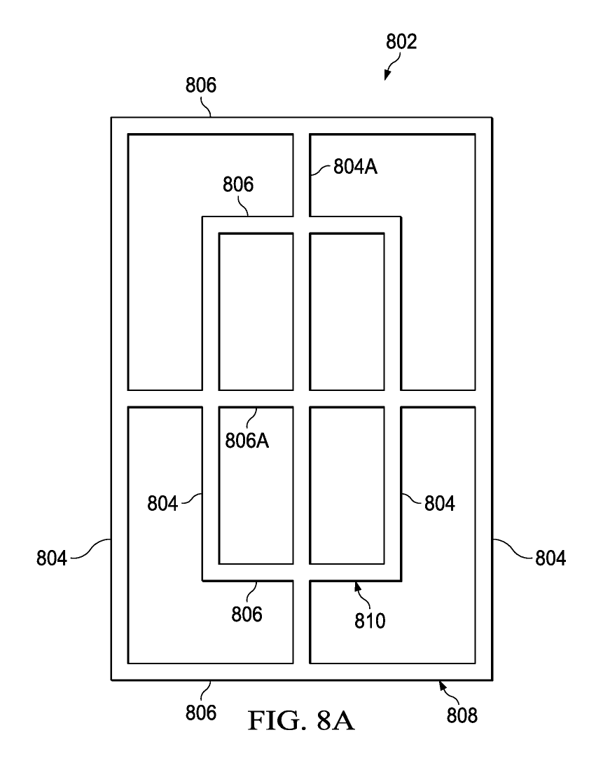

Referring now to FIGS. 7A and 7B, an example embodiment of a force sensing structure 700 is shown having rows of triangularly shaped sensing electrodes 702. FIG. 7A shows a cross-sectional view of the triangularly shaped sensing electrode 702, wherein the electrode 702 has a base portion 704 and a tip portion 708. The sensing electrode 702 has a thickness T1, which varies along the length L1 of the sensing electrode 702 such that the thickness T1 is largest at the base portion 704 and is smallest at the tip portion 708. In some embodiments, the thickness T1 is selected to vary so that it follows the exponential function: y=exp(x), wherein y is the thickness T1 and x is a point along the length L1 of the sensing electrode 702, such that the thickness T1 increases exponentially as it approaches the base portion 704. In some embodiments, the sensing electrode 702 may have a thickness of 100 μm at the tip portion 708, and a thickness of 1000 μm at the base portion 704.

FIG. 7B shows an overhead view of the force sensing structure 700, wherein the triangularly shaped sensing electrodes 702 are arranged in rows. Each row includes two sensing electrodes 702, wherein the sensing electrodes 702 in a row are positioned with their base portions 704 located proximate a perimeter location 706 of the sensing structure 700, and with their tip portions 708 positioned proximate a center location 705 of the row. As discussed herein, the displacement potential of the sensing electrodes 702 may be greater in locations near the center locations 705 of each row, and may be less in locations near the perimeter locations 706. In the embodiment illustrated in FIG. 7B, the sensing electrodes 702 of a row are shown electrically connected at their respective tip portions 708. It should be appreciated, however, that in some embodiments the sensing electrodes 702 in a row are not electrically connected.

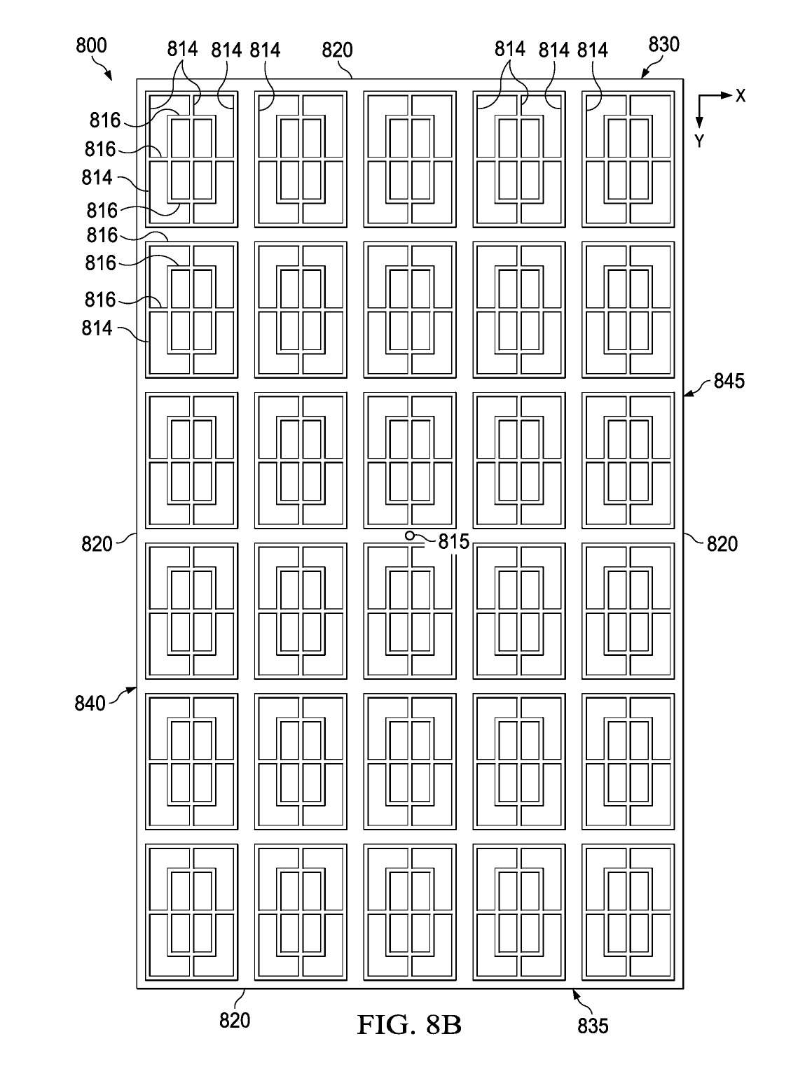

Referring now to FIGS. 8A and 8B, an example embodiment of a force sensing structure 800 is shown having a matrix of rectangle-shaped sensing electrodes 802. FIG. 8A shows the rectangle-shaped sensing electrode 802 from an overhead view. The electrode 802 is comprised of vertical electrode portions 804 and horizontal electrode portions 806 arranged to form an outer rectangular pattern 808 and an inner rectangular pattern 810. The outer rectangular pattern 808 and inner rectangular pattern 810 are each divided into smaller rectangular shapes by interior vertical portions 804A and interior horizontal portions 806A. Each of the vertical electrode portions 804 and horizontal electrode portions 806 have a thickness (not shown), which varies depending upon the position of the vertical electrode portions 804 and horizontal electrode portions 806 with respect to a center portion of the sensing structure 800. In some embodiments, the thickness is selected to vary so that it follows the exponential function: y=exp(x), wherein y is the thickness and x corresponds to a distance from the center portion 815 (see FIG. 8B) of the force sensing structure 800, such that the thicknesses of the vertical electrode portions 804 and horizontal electrode portions 806 increase exponentially as they approach the perimeter 820 (see FIG. 8B) of the force sensing structure 800. In some embodiments, each rectangle-shaped sensing electrode 802 has a thickness that is uniform across the width of the electrode 802, but the thickness of the sensing electrodes 802 comprising the sensing structure 800 increases the closer the sensing electrodes 802 are positioned relative to the perimeter 820 of the sensing structure 800.

FIG. 8B shows an overhead view of the force sensing structure 800, wherein the rectangle-shaped sensing electrodes 802 are arranged in a matrix formation. The matrix of rectangle-shaped sensing electrodes 802 is formed by columns of sensing structures 814 and rows of sensing structures 816. The columns of sensing structures 814 extend between a top edge 830 of the sensing structure 800 and a bottom edge 835 of the sensing structure 800 to form the vertical electrode portions 804 of each sensing electrode 802. The rows of sensing structures 816 extend between a first side 840 of the sensing structure 800 and a second side 845 of the sensing structure 800 to form the horizontal electrode portions 806 of each sensing electrode 802.

The columns of sensing structures 814 and rows of sensing structures 816 each have a thickness and a width, wherein the thicknesses are determined based upon the distance of the respective column or row of sensing structures 814/816 from the center portion 815 of the force sensing structure 800. For example, columns of sensing structures 814 that are positioned farther away from the center portion 815 have a thickness that is greater than that of columns of sensing structures 814 that are closer to the center portion 815. Similarly, rows of sensing structures 816 that are positioned farther away from the center portion 815 have a thickness that is greater than that of rows of sensing structures 816 that are closer to the center portion 815. In some embodiments, the thicknesses of the respective columns and rows of sensing structures 814/816 are selected to vary so that it follows the exponential function: y=exp(x), wherein y is the thickness and x corresponds to a distance from the center portion 815 of the force sensing structure 800, such that the thicknesses of the columns and rows of sensing structures 814/816 increase exponentially as they approach the perimeter 820 of the force sensing structure 800. In some embodiments, columns of sensing structures 814 located farthest away from the center portion 815 have a thickness of 498 μm, whereas columns of sensing structures 814 located closest to the center portion 815 have a thickness of 150 μm. In some embodiments, rows of sensing structures 816 located farthest away from the center portion 815 have a thickness of 608 μm, whereas rows of sensing structures 816 located closest to the center portion 815 have a thickness of 150 μm.

In some embodiments, the widths of the columns and rows of sensing structures 814/816 depend upon whether the respective columns and rows of sensing structures 814/816 form an outer rectangular pattern 808 or inner rectangular pattern 810. For example, columns of sensing structures 814 forming the outer rectangular patterns 808 may have a width of 16.76 mm, whereas columns of sensing structures 814 forming the inner rectangular patterns 810 may have a width of 8.38 mm. Similarly, rows of sensing structures 816 forming the outer rectangular patterns 808 may have a width of 11.39 mm, whereas rows of sensing structures 816 forming the inner rectangular patterns 810 may have a width of 5.70 mm.

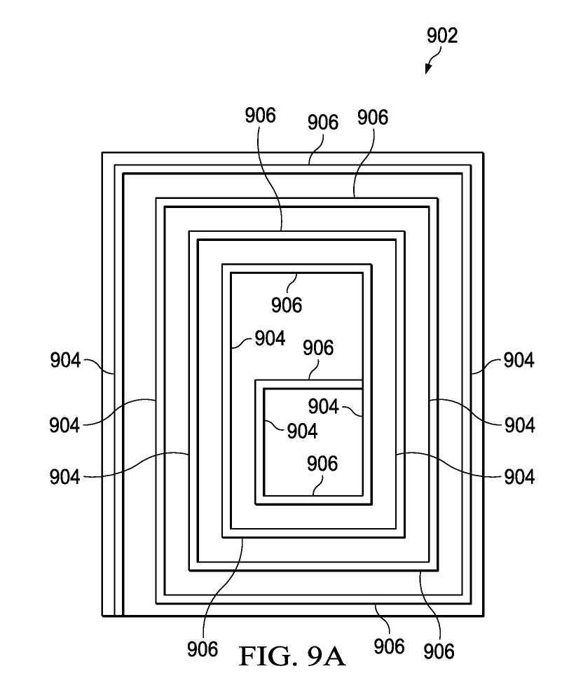

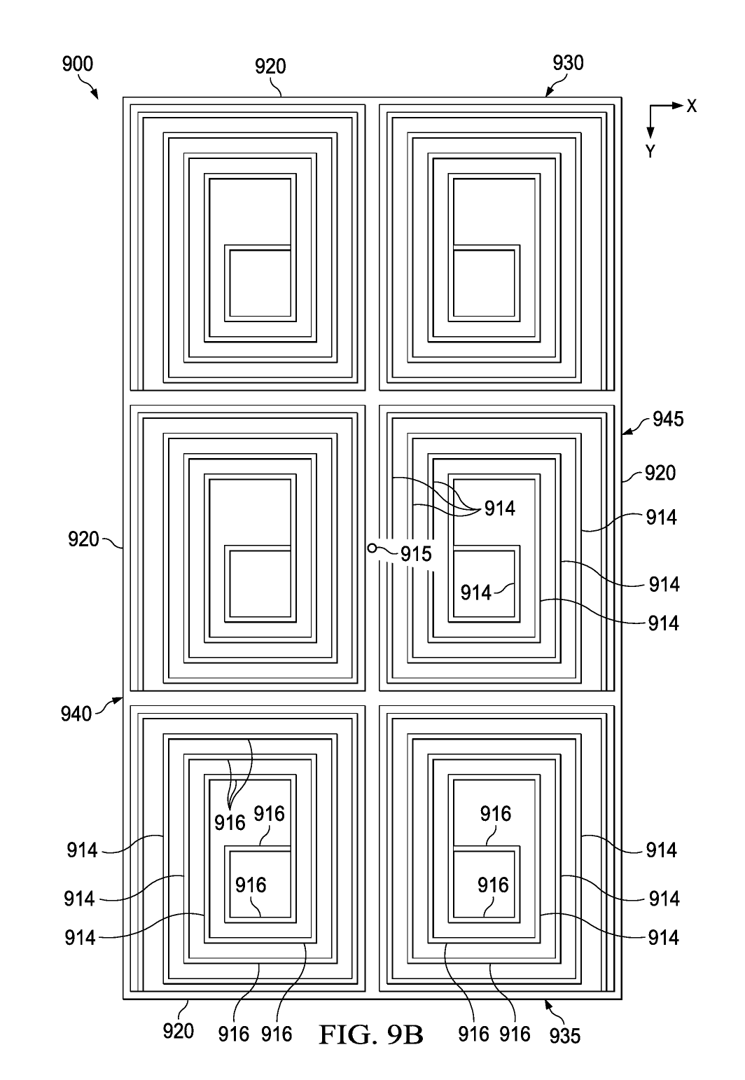

Referring now to FIGS. 9A and 9B, an example embodiment of a force sensing structure 900 is shown having a matrix of rectangular sensing electrodes 902 having a spiral pattern. FIG. 9A shows the sensing electrode 902 from an overhead view. The sensing electrode 902 is comprised of vertical electrode portions 904 and horizontal electrode portions 906 connected together and arranged to form a spiral pattern. Each of the vertical electrode portions 904 and horizontal electrode portions 906 have a thickness (not shown), which varies depending upon the position of the vertical electrode portions 904 and horizontal electrode portions 906 with respect to a center portion of the sensing structure 900. In some embodiments, the thickness is selected to vary so that it follows the exponential function: y=exp(x), wherein y is the thickness and x corresponds to a distance from the center portion 915 (see FIG. 9B) of the force sensing structure 900, such that the thicknesses of the vertical electrode portions 904 and horizontal electrode portions 906 increase exponentially as they approach the perimeter 920 (see FIG. 9B) of the force sensing structure 900.

FIG. 9B shows an overhead view of the force sensing structure 900, wherein the sensing electrodes 902 are arranged in a matrix formation. The matrix of sensing electrodes 902 is formed by columns of sensing structures 914 and rows of sensing structures 916. The columns of sensing structures 914 extend between a top edge 930 of the sensing structure 900 and a bottom edge 935 of the sensing structure 900 to form the vertical electrode portions 904 of each sensing electrode 902. The rows of sensing structures 916 extend between a first side 940 of the sensing structure 900 and a second side 945 of the sensing structure 900 to form the horizontal electrode portions 906 of each sensing electrode 902.

The columns of sensing structures 914 and rows of sensing structures 916 each have a thickness, wherein the thicknesses are determined based upon the distance of the respective column or row of sensing structures 914/916 from the center portion 915 of the force sensing structure 900. For example, columns of sensing structures 914 that are positioned farther away from the center portion 915 have a thickness that is greater than that of columns of sensing structures 914 that are closer to the center portion 915. Similarly, rows of sensing structures 916 that are positioned farther away from the center portion 915 have a thickness that is greater than that of rows of sensing structures 916 that are closer to the center portion 915. In some embodiments, the thicknesses of the respective columns and rows of sensing structures 914/916 are selected to vary so that it follows the exponential function: y=exp(x), wherein y is the thickness and x corresponds to a distance from the center portion 915 of the force sensing structure 900, such that the thicknesses of the columns and rows of sensing structures 914/916 increase exponentially as they approach the perimeter 920 of the force sensing structure 900. In some embodiments, columns of sensing structures 914 located farthest away from the center portion 915 have a thickness of 334 μm, whereas columns of sensing structures 914 located closest to the center portion 915 have a thickness of 150 μm. In some embodiments, rows of sensing structures 916 located farthest away from the center portion 915 have a thickness of 550 μm, whereas rows of sensing structures 916 located closest to the center portion 915 have a thickness of 150 μm.

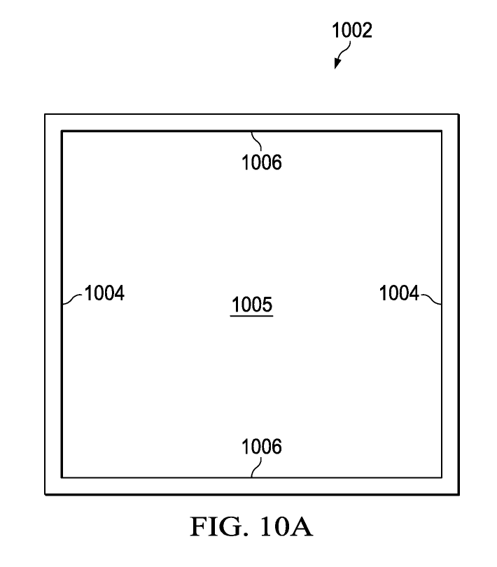

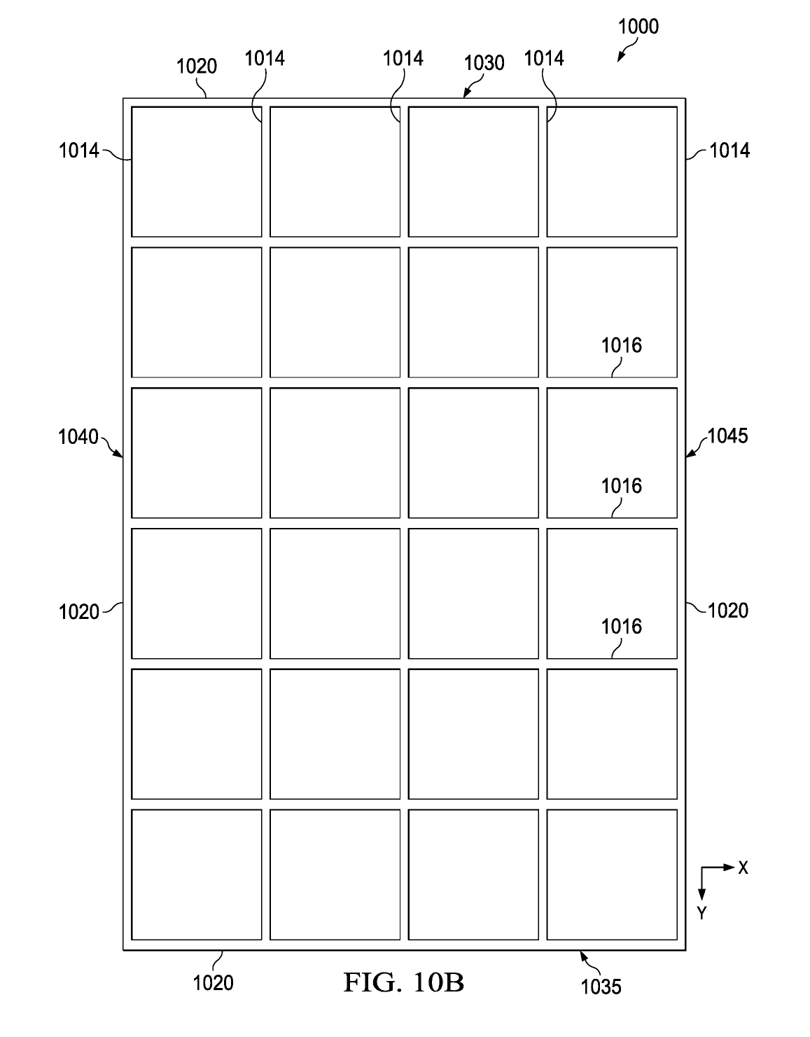

Referring now to FIGS. 10A and 10B, an example embodiment of a force sensing structure 1000 is shown having a matrix of rectangular sensing electrodes 1002, wherein the rectangular sensing electrodes 1002 have a rectangular pattern defining an aperture. FIG. 10A shows the sensing electrode 1002 from an overhead view. The sensing electrode 1002 is comprised of vertical electrode portions 1004 and horizontal electrode portions 1006 connected together and arranged to form a rectangle pattern, wherein the rectangle pattern defines an aperture 1005 between the vertical electrode portions 1004 and horizontal electrode portions 1006.

FIG. 10B shows an overhead view of the force sensing structure 1000, wherein the sensing electrodes 1002 of FIG. 10A are arranged in a matrix formation. The matrix of sensing electrodes 1002 is formed by columns of sensing structures 1014 and rows of sensing structures 1016. The columns of sensing structures 1014 extend between a top edge 1030 of the sensing structure 1000 and a bottom edge 1035 of the sensing structure 1000 to form the vertical electrode portions 1004 of each sensing electrode 1002. The rows of sensing structures 1016 extend between a first side 1040 of the sensing structure 1000 and a second side 1045 of the sensing structure 1000 to form the horizontal electrode portions 1006 of each sensing electrode 1002.

Each of the vertical electrode portions 1004 and horizontal electrode portions 1006 have a thickness (not shown), which varies depending upon the position of the vertical electrode portions 1004 and horizontal electrode portions 1006 with respect to a perimeter location 1020 of the sensing structure 1000. Specifically, in some embodiments, the vertical electrode portions 1004 and horizontal electrode portions 1006 that are positioned proximate the perimeter locations 1020 of the sensing structure 1000 have a thickness that is greater than that of the vertical electrode portions 1004 and horizontal electrode portions 1006 that are not positioned proximate the perimeter locations 1020 of the sensing structure 1000. For example, in some embodiments, vertical electrode portions 1004 and horizontal electrode portions 1006 located proximate perimeter locations 1020 of the sensing structure 1000 have a thickness of 200 μm, whereas vertical electrode portions 1004 and horizontal electrode portions 1006 that are not located along the perimeter 1020 have a thickness of 100 μm. In some embodiments, the thickness of the respective vertical electrode portions 1004 and horizontal electrode portions 1006 depends upon the size of the sensing structure 1000 and the number of sensing electrodes 1002 comprising the sensing structure 1000.

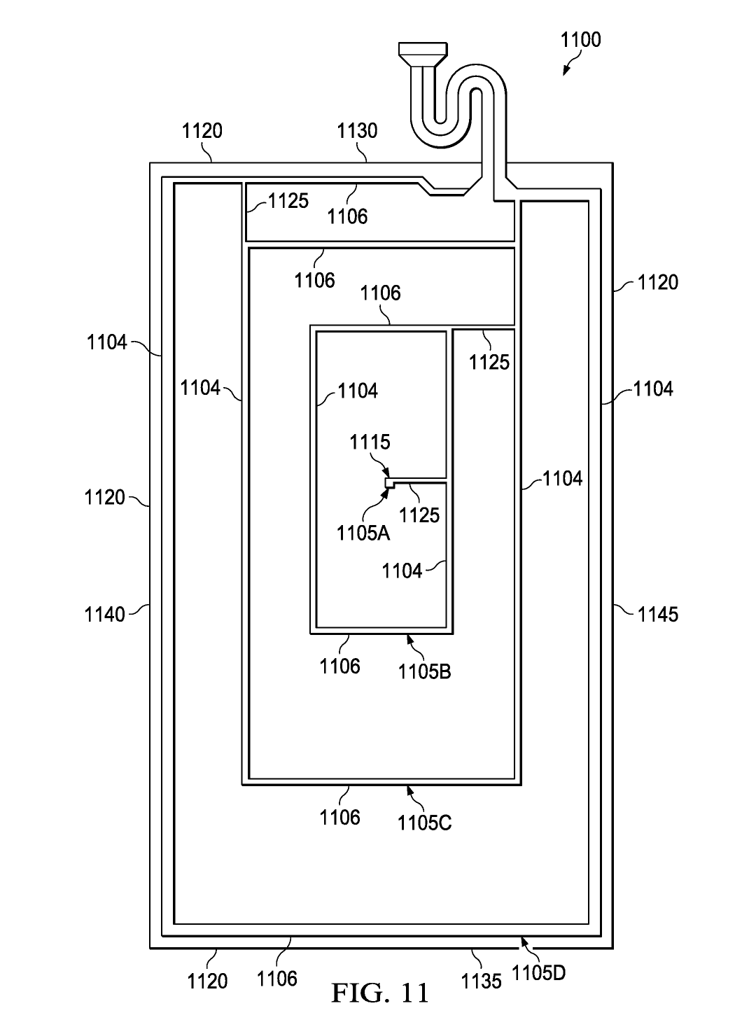

Referring now to FIG. 11, an example embodiment of a force sensing structure 1100 is shown having a plurality of rectangular rings 1105. FIG. 11 shows the force sensing structure 1100 from an overhead view. The force sensing structure 1100 is comprised of vertical electrode portions 1104 and horizontal electrode portions 1106 arranged to form a pattern of rectangular rings 1105. The vertical electrode portions 1104 extend between a top edge 1130 of the sensing structure 1100 and a bottom edge 1135 of the sensing structure 1100 to form portions of the rectangular rings 1105. The horizontal electrode portions 1106 extend between a first side 1140 of the sensing structure 1100 and a second side 1145 of the sensing structure 1100 to form portions of the rectangular rings 1105. The embodiment of the force sensing structure 1100 shown in FIG. 11 illustrates four rectangular rings 1105: a first rectangular ring 1105A located proximate a center location 1115 of the sensing structure 1100, a second rectangular ring 1105B positioned around the first rectangular ring 1105A and electrically connected to the first rectangular ring 1105A by a connecting member 1125, a third rectangular ring 1105C positioned around the second rectangular ring 1105B and electrically connected to the second rectangular ring 1105B by a connecting member 1125, and a fourth rectangular ring 1105D positioned around the third rectangular ring 1105C and connected to the third rectangular ring 1105C by a connecting member 1125.

Each of the vertical electrode portions 1104 and horizontal electrode portions 1106 comprising each rectangular ring 1105 has a thickness (not shown), which varies depending upon the position of the rectangular ring 1105 with respect to a center portion 1115 of the sensing structure 1100. For example, in the embodiment illustrated in FIG. 11, the vertical electrode portions 1104 and horizontal electrode portions 1106 comprising rectangular ring 1105A, which is closest to the center portion 1115, have a thickness of 100 μm, whereas the vertical electrode portions 1104 and horizontal electrode portions 1106 comprising rectangular ring 1105D, which is farthest from the center portion 1115, have a thickness of 429.26 μm. The vertical electrode portions 1104 and horizontal electrode portions 1106 comprising rectangular ring 1105B have a thickness of 162.52 μm, and the vertical electrode portions 1104 and horizontal electrode portions 1106 comprising rectangular ring 1105C have a thickness of 264.13 μm. In some embodiments, the thickness is selected to vary so that it follows the exponential function: y=exp(x), wherein y is the thickness and x corresponds to a distance of the ring 1105 from the center portion 1115 of the force sensing structure 1100, such that the thicknesses of the vertical electrode portions 1104 and horizontal electrode portions 1106 comprising a particular ring 1105 increase exponentially as they approach the perimeter 1120 of the force sensing structure 1100.

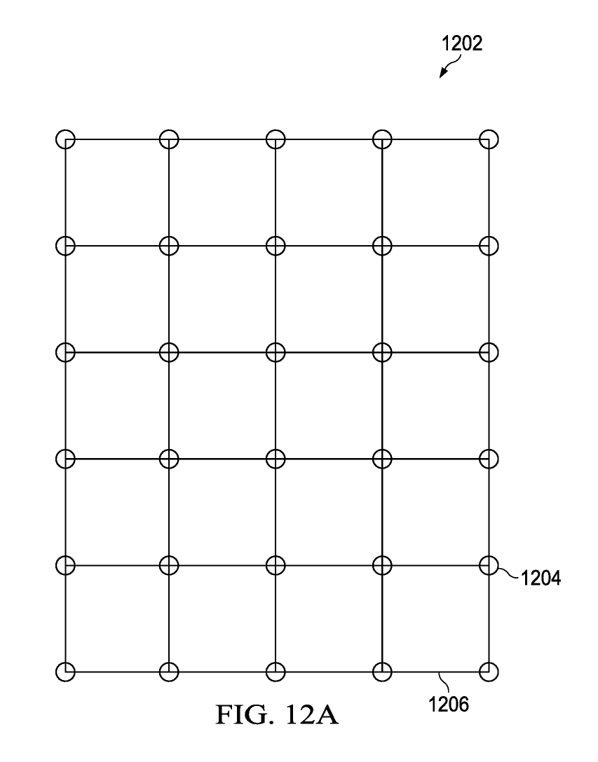

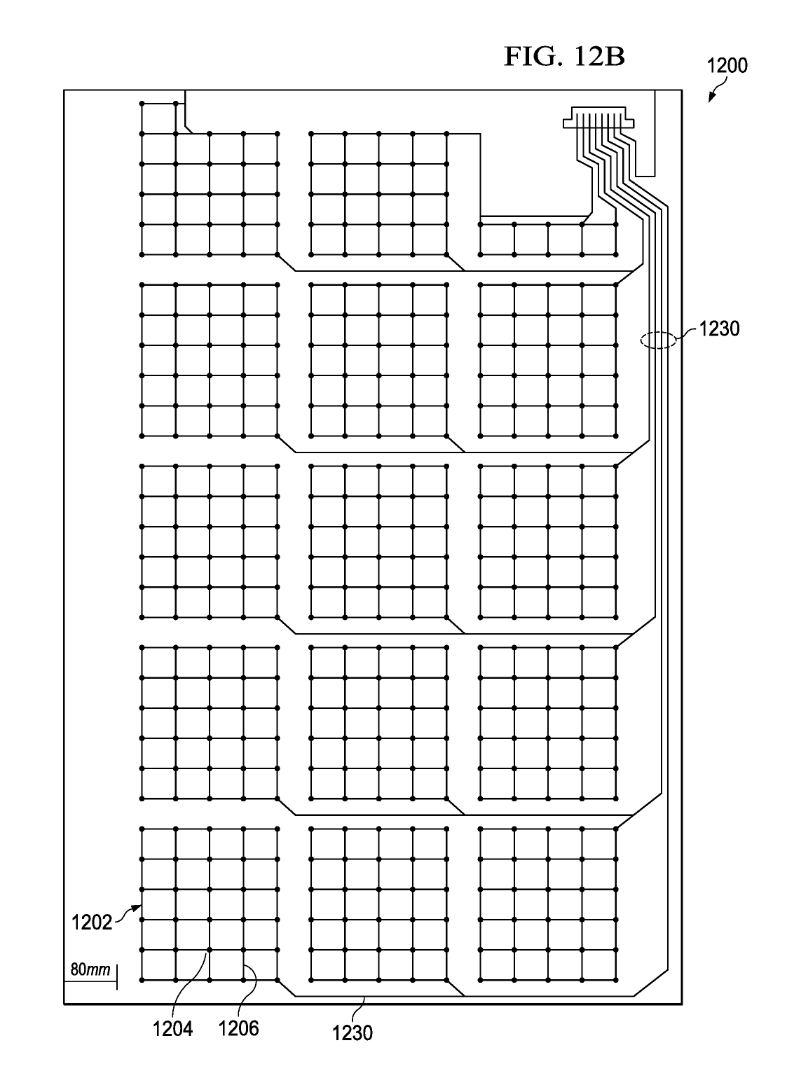

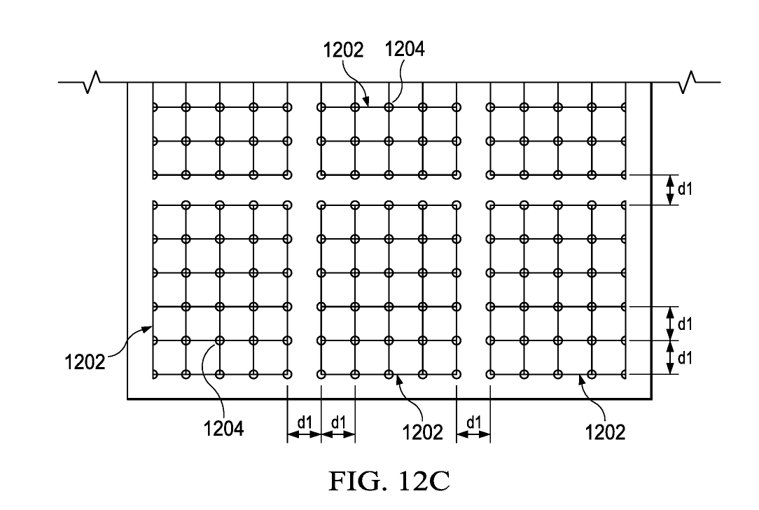

Referring now to FIGS. 12A, 12B, and 12C, an example embodiment of a force sensing structure 1200 is shown having a matrix of dot-pattern sensing electrodes 1202. FIG. 12A shows the dot-pattern sensing electrode 1202 from an overhead view. The electrode 1202 is comprised of a matrix of nodes 1204 connected via traces 1206. In some embodiments, the nodes 1204 are comprised of copper, although other materials may be used. In some embodiments, each node 1204 may be an intersection of two traces 1206 (i.e., a row trace and a column trace). In other embodiments, each node 1204 may be formed to have a diameter that is larger than the width of a trace 1206, or is otherwise selected based upon parasitic capacitance and the drive ability of the sensing circuitry. For example, the diameter of a node 1204 may be determined based on the amount of parasitic capacitance generated with the node 1204 and the number of channels comprising the sensing electrode 1202. Generally, the larger the diameter of a node 1204, the greater the parasitic capacitance generated with the node 1204. Additionally, each channel of the sensing electrode 1202 should be designed to tolerate the same amount of parasitic capacitance. Thus, the more channels comprising the sensing electrode 1202, the larger the node diameter that is supported by that sensing electrode 1202. Conversely, if the sensing electrode 1202 has fewer channels, the nodes 1204 are selected to have a smaller diameter.

In the embodiment shown in FIGS. 12A and 12B, the matrix of nodes 1204 forms a rectangular shape, wherein each node 1204 is equidistant from adjacent nodes 1204. However, it should be appreciated that other patterns may be implemented in accordance with the present disclosure. For example, the size of the sensing electrode 1202, or the number of sensing electrodes 1202 comprising the force sensing structure 1200 may vary depending on the active area and the number of channels comprising the touchscreen panel.

FIG. 12B shows an overhead view of the force sensing structure 1200, wherein the dot-pattern sensing electrodes 1202 are arranged in a matrix formation. Each dot-pattern sensing electrode 1202 is coupled at one of its nodes 1204 to sensing circuitry (not shown) via a trace 1230. Accordingly, all the nodes 1204 of a particular sensing electrode 1202 are coupled to the sensing circuitry via traces 1206 and traces 1230.

In some embodiments, the dot-pattern sensing electrodes 1202 are positioned on the force sensing structure 1200 such that the distance between nodes 1204 of adjacent sensing electrodes 1202 is equal to the spacing between nodes 1204 of a same sensing electrode 1202. In other words, each node 1204 comprising the sensing structure 1200 is equally spaced from its adjacent nodes 1204, even if those adjacent nodes form a portion of a different sensing electrode 1202. For example, FIG. 12C illustrates a close-up view of the sensing structure 1200 showing a distance d1 between each of the nodes 1204 comprising the illustrated sensing electrodes 1202. Each of the nodes 1204 comprising a particular sensing electrode 1202 is spaced from adjacent nodes of the same sensing structure 1202 by a distance of d1. Similarly, adjacent nodes 1204 of two adjacent sensing structures 1202 are also spaced by a distance of d1.

It should be appreciated that the dot-pattern sensing electrodes 1202 and force sensing structure 1200 operate in a similar to the embodiments discussed above. Accordingly, the nodes 1204 are spaced apart from a ground plane by a distance. When a user touch (force touch) is applied to the surface of the force sensing structure 1200, the force of the touch causes a displacement of the nodes 1204 positioned beneath the force touch, such that the nodes 1204 flex in a direction toward the ground plane, thereby causing a relative change in the distance between the nodes 1204 and the ground plane, and altering the capacitance measured at the sensing electrodes 1202. This change in the capacitance is measured by control circuitry (such as, for example, the control circuitry 402 or 406 in FIG. 4) to determine the force of the force touch or to otherwise assign a value to the measured force touch. This value correlates to some user touch input (i.e., force touch input) applied in a direction substantially perpendicular to the touch surface, the sensing electrodes 1202, or the ground plane. In some embodiments, this user touch input (i.e., the force touch input) is used by the control circuitry or other circuitry in the electronic device to perform a task, or is otherwise associated with a user input.

The foregoing description has provided by way of exemplary and non-limiting examples a full and informative description of one or more exemplary embodiments of this invention. However, various modifications and adaptations may become apparent to those skilled in the relevant arts in view of the foregoing description when read in conjunction with the accompanying drawings and the appended claims. However, all such and similar modifications of the teachings of this invention will still fall within the scope of this invention as defined in the appended claims.

What is claimed is:

1. A capacitive sensing structure, comprising:
a touch surface;
one or more sensing electrodes disposed between the touch surface and a ground plane, the one or more sensing electrodes having a matrix of nodes, wherein each node is spaced apart from an adjacent node by a first distance; and
control circuitry configured to sense a capacitance at the one or more sensing electrodes, wherein a change in the capacitance at the one or more sensing electrodes is indicative of a force touch.

2. The capacitive sensing structure of claim 1, wherein the control circuitry is further configured to indicate detection of a force touch in response to detecting a change in the capacitance.

3. The capacitive sensing structure of claim 1, wherein the force touch is a user touch input in a direction substantially perpendicular to at least one of the touch surface, the one or more sensing electrodes, and the ground plane.

4. The capacitive sensing structure of claim 1, further comprising a sensing layer positioned between the touch surface and the one or more sensing electrodes, the sensing layer comprising:
one or more rows of first electrically conductive sensor structures; and
one or more columns of second electrically conductive sensor structures,
wherein the control circuitry is further configured to sense a capacitance at the sensing layer, the capacitance at the sensing layer indicative of a two-dimensional user touch input along a direction substantially parallel to the sensing layer.

5. The capacitive sensing structure of claim 1, wherein the one or more sensing electrodes are configured to flex at a location of the force touch pursuant to a displacement potential of the one or more sensing electrodes at the location of the force touch.

6. The capacitive sensing structure of claim 1, wherein the matrix of nodes comprising one of the one or more sensing electrodes are electrically coupled via a first trace.

7. The capacitive sensing structure of claim 6, wherein one or more of the nodes comprising one of the one or more sensing electrodes have a diameter larger than a width of the first trace.

8. The capacitive sensing structure of claim 1, wherein the one or more sensing electrodes comprises a matrix of sensing electrodes, wherein each sensing electrode is coupled to the control circuitry via a second trace.

9. The capacitive sensing structure of claim 1, wherein the matrix of nodes comprising one of the one or more sensing electrodes form a rectangular shape.

10. A capacitive sensing structure, comprising:
one or more sensing electrodes formed from a matrix of nodes, the one or more sensing electrodes defined by the matrix of nodes and disposed between a ground plane and a touch surface, wherein each node is spaced apart from an adjacent node by a first distance, and wherein each of the one or more sensing electrodes is spaced apart from an adjacent sensing electrode by the first distance; and
control circuitry configured to sense a capacitance at the one or more sensing electrodes, wherein a change in the capacitance at the one or more sensing electrodes is indicative of a force touch.

11. The capacitive sensing structure of claim 10, wherein the change in the capacitance at the nodes of the one or more sensing electrodes is indicative of a change in a distance between one or more of the sensing electrodes and the ground plane.

12. The capacitive sensing structure of claim 10, wherein the control circuitry is further configured to indicate detection of a force touch in response to detecting a change in the capacitance.

13. The capacitive sensing structure of claim 10, wherein the force touch is a user touch input in a direction substantially perpendicular to at least one of the touch surface, the one or more sensing electrodes, and the ground plane.

14. The capacitive sensing structure of claim 10, further comprising a sensing layer positioned between the touch surface and the one or more sensing electrodes, the sensing layer comprising:
one or more rows of first electrically conductive sensor structures; and
one or more columns of second electrically conductive sensor structures,
wherein the control circuitry is further configured to sense a capacitance at the sensing layer, the capacitance at the sensing layer indicative of a two-dimensional user touch input along a direction substantially parallel to the sensing layer.

15. The capacitive sensing structure of claim 10, wherein the one or more sensing electrodes are configured to flex at a location of the force touch pursuant to the displacement potential of the nodes comprising the one or more sensing electrodes at the location of the force touch.

16. The capacitive sensing structure of claim 10, wherein the matrix of nodes comprising one of the one or more sensing electrodes are electrically coupled via a first trace.

17. The capacitive sensing structure of claim 16, wherein one or more of the nodes comprising one of the one or more sensing electrodes have a diameter larger than a width of the first trace.

18. The capacitive sensing structure of claim 10, wherein the one or more sensing electrodes comprises a matrix of sensing electrodes, wherein each sensing electrode is coupled to the control circuitry via a second trace.

19. The capacitive sensing structure of claim 10, wherein the matrix of nodes comprising one of the one or more sensing electrodes form a rectangular shape.
